(19) United States
(12) Patent Application Publication
(10) Pub. No.: US 2026/0091459 A1
(43) Pub. Date: Apr. 2, 2026

(54) HEAT EXCHANGER INTEGRATED AIR DUCT ASSEMBLY AND BATTERY DETECTION DEVICE

(71) Applicant: ZHUHAI TITANS NEW POWER ELECTRONICS CO., LTD, Zhuhai (CN)

(72) Inventors: Pengcheng XIANG, Zhuhai (CN); Yuntong ZHANG, Zhuhai (CN); Bin LIU, Zhuhai (CN)

(21) Appl. No.: 19/277,992

(22) Filed: Jul. 23, 2025

(30) Foreign Application Priority Data
Sep. 30, 2024 (CN) 202422408755.7

(51) Int. Cl. B23Q 11/10; H01M 10/04

(52) U.S. Cl. CPC B23Q 11/10; H01M 10/0404

(57) ABSTRACT

A heat exchanger integrated air duct assembly and a battery detection device are provided. The heat exchanger integrated air duct assembly includes a box body, a heat exchanger, and at least one fan module. The cavity is defined inside the box body. An airflow passage port communicated with the cavity is defined on either of two sides of the box body in a Y direction. The fan module is disposed on a bottom wall of the box body. The fan module is configured to spray gases inside the cavity downward to form a negative pressure inside the cavity. The heat exchanger is disposed inside the cavity and located on either of the two sides in the Y direction. A projection of the heat exchanger in the Y direction at least partially overlaps with the corresponding airflow passage port to cool down the gases entering into the cavity.

### CROSS-REFERENCE TO RELATED APPLICATION

This application claims priority to and the benefit of Chinese Patent Application No. 202422408755.7, filed on Sep. 30, 2024, and the disclosure of which is incorporated herein by reference in its entirety.

### TECHNICAL FIELD

The present disclosure relates to the field of battery production technologies, and in particular to a heat exchanger integrated air duct assembly and a battery detection device.

### BACKGROUND

Capacity-grading integrated machines are important devices used in a process of producing lithium batteries. It is mainly used in formation and capacity-grading processes of batteries. The capacity-grading integrated machines will generate a lot of heat during operation, so the current capacity-grading integrated machines are equipped with heat dissipation function design to ensure that the machines are in a suitable operating temperature environment.

The current integrated capacity-grading machines generally adopt a design of a heat exchange air duct. Specifically, a heat exchanger cooperates with a fan to form the heat exchange air duct inside the capacity-grading integrated machine, so as to achieve a purpose of heat dissipation.

However, for the current capacity-grading integrated machines, heat dissipation function modules based on the heat exchanger and the fan are disposed on left and right sides of a cabinet of the capacity-grading integrated machine, which causes that a width of the capacity-grading integrated machine as a whole is too wide, resulting in inconvenience during transportation. In addition, different models of the capacity-grading integrated machines require the design of different heat dissipation function modules to form suitable dedicated air ducts, resulting in high manufacturing costs.

### SUMMARY

According to one aspect of the present disclosure, a heat exchanger integrated air duct assembly is provided. The heat exchanger integrated air duct assembly includes a box body, a heat exchanger, and at least one fan module. The cavity is defined inside the box body, and an airflow passage port communicated with the cavity is defined on either of two sides of the box body in a Y direction. The fan module is disposed on a bottom wall of the box body. The fan module is configured to spray gases inside the cavity downward to form a negative pressure inside the cavity. At least a part of the heat exchanger is disposed inside the cavity and located on the two sides of the box body in the Y direction. A projection of the heat exchanger in the Y direction at least partially overlaps with the corresponding airflow passage port to cool down the gases entering into the cavity through the airflow passage port.

According to another aspect of the present disclosure, a battery detection device is provided. The battery detection device includes a cabinet, a press bed assembly, and the heat exchanger integrated air duct assembly mentioned above. The heat exchanger integrated air duct assembly and the press bed assembly are disposed inside the cabinet. The heat exchanger integrated air duct assembly is located above the press bed assembly in a Z direction. The heat exchanger integrated air duct assembly is capable of spraying airflow toward the press bed assembly to dissipate heat from the press bed assembly.

### BRIEF DESCRIPTION OF THE DRAWINGS

To describe the technical proposals of the embodiments of the present disclosure more clearly, the following briefly introduces the accompanying drawings used in the description of the embodiments of the present disclosure. Apparently, the accompanying drawings described below illustrate merely some exemplary embodiments of the present disclosure, and those skilled in the art may derive other drawings from the drawings without making creative efforts.

FIG. 1 is a schematic view of a battery detection device according to some embodiments of the present disclosure from a viewing angle.

FIG. 2 is a schematic view of a heat exchanger integrated air duct assembly in FIG. 1 from a viewing angle.

FIG. 3 is a schematic view of the heat exchanger integrated air duct assembly in FIG. 2 from another viewing angle.

FIG. 4 is a schematic view of the heat exchanger integrated air duct assembly in FIG. 2 from yet another viewing angle.

Reference numerals are illustrated as follows:
1000, battery detection device;
100, heat exchanger integrated air duct assembly;
10, box body; 11, fan installation guide rail; 12, pull handle; R, cavity; C, airflow passage port; H1, fan installation port; H2, heat exchanger installation port;
20, fan module; 21, fan; 22, pull handle; 23, adapter plate; 24, fan installation bottom plate;
30, heat exchanger; 31, pipeline joint;
400, cabinet; 500, press bed assembly; 600, pipeline; 700, battery tray.

### DETAILED DESCRIPTION

In the present disclosure, unless otherwise explicitly specified and defined, the terms “install”, “connect”, “connection”, and “fix” should be interpreted broadly. For example, the terms may indicate fixed connections, detachable connections, or integrated connections; may indicate mechanical connections, may also indicate electrical connections; may also indicate direct connections or indirect connections via intervening structures; may also indicate inner communications of two elements or interaction relationships between two elements, may also indicate direct connections or indirect connections via intervening structures; may also indicate inner communications of two elements or interaction relationships between two elements. For those skilled in the art, the specific meanings of these terms in the present disclosure can be understood based on the specific situations.

In the description of this description, when terms such as “one embodiment”, “some embodiments”, “examples”, “specific examples”, or “some examples” appear, it means that specific features, structures, materials, or characteristics described in connection with the embodiment or example are included in at least one embodiment or example of the present disclosure. In this description, schematic expressions of the above-described terms are not necessarily directed to the same embodiments or examples. Moreover, the specific features, structures, materials, or characteristics described may be combined in any one or more embodiments or examples in a suitable manner. In addition, those skilled in the art can combine different embodiments or examples described in this description and features of different embodiments or examples without contradicting each other.

In the present disclosure, “X direction”, “Y direction”, and “Z direction” mentioned are determined based on rectangular coordinates constructed by a battery detection device 1000 provided in the present disclosure. The X direction refers to a vertical direction and also refers to a front-rear direction. The Y direction refers to a horizontal direction and also refers to a left-right direction. The Z direction refers to a vertical direction and also refers to an up-down direction.

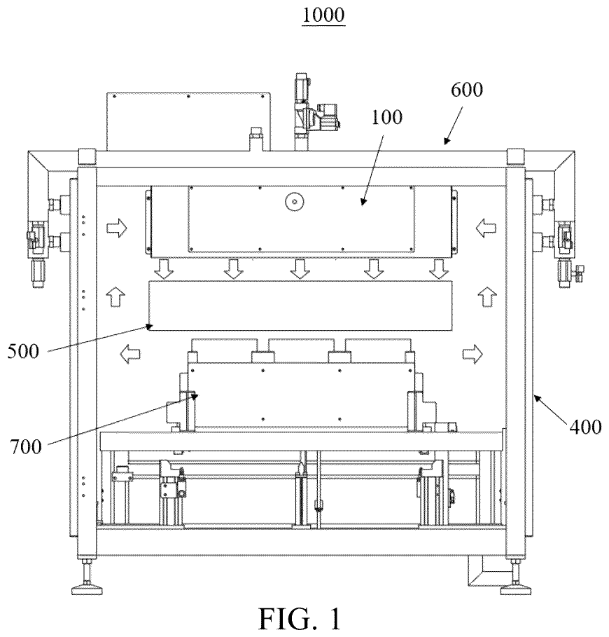

FIG. 1 is a schematic view of the battery detection device 1000 according to some embodiments of the present disclosure from a viewing angle. Referring to FIG. 1, the battery detection device 1000 includes a heat exchanger integrated air duct assembly 100, a cabinet 400, and a press bed assembly 500.

The heat exchanger integrated air duct assembly 100 and the press bed assembly 500 are disposed inside the cabinet 400. The heat exchanger integrated air duct assembly 100 is located above the press bed assembly 500 in a Z direction.

The heat exchanger integrated air duct assembly 100 is capable of spraying an airflow toward the press bed assembly 500 to dissipate heat from the press bed assembly 500.

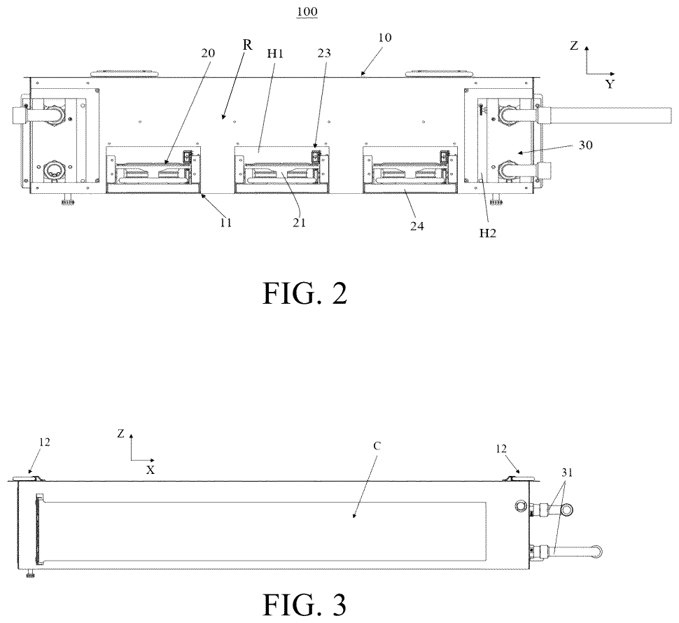

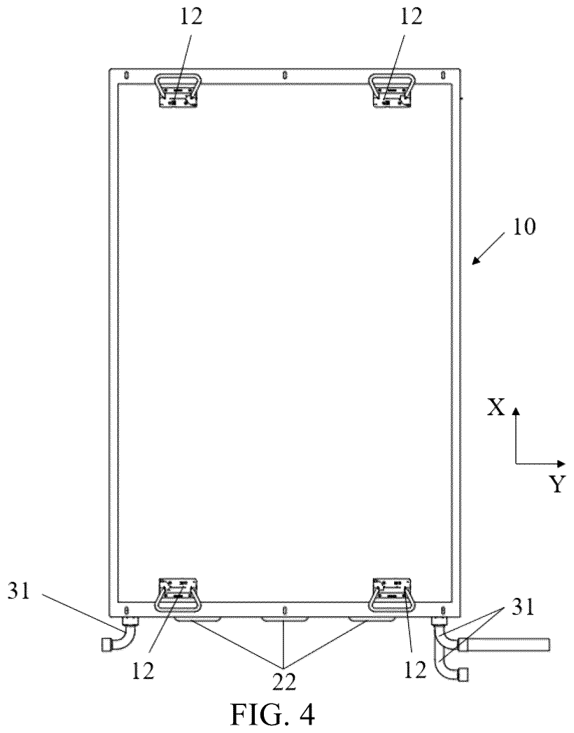

FIG. 2 is a schematic view of the heat exchanger integrated air duct assembly 100 in FIG. 1 from a viewing angle. FIG. 3 is a schematic view of the heat exchanger integrated air duct assembly 100 in FIG. 2 from another viewing angle. FIG. 4 is a schematic view of the heat exchanger integrated air duct assembly 100 in FIG. 2 from yet another viewing angle.

Referring to FIGS. 2 to 4, the heat exchanger integrated air duct assembly 100 includes a box body 10, a heat exchanger 30, and at least one fan module 20. A cavity R is defined inside the box body 10. An airflow passage port C communicated with the cavity R is defined on either of two sides of the box body 10 in a Y direction.

The fan module 20 is disposed on a bottom wall of the box body 10. The fan module 20 is disposed to spray gases inside the cavity R downward to form a negative pressure inside the cavity R. At least a part of the heat exchanger 30 is disposed inside the cavity R and located on either of the two sides of the box body 10 in the Y direction.

A projection of the heat exchanger 30 in the Y direction at least partially overlaps with the corresponding airflow passage port C to cool down the gases entering into the cavity R through the airflow passage port C.

In these embodiments, the cavity R can be formed inside the box body 10, and the two sides of the box body 10 in the Y direction are provided with the airflow passage port C. The fan module 20 and the heat exchanger 30 are disposed inside the cavity R. The fan module 20 is capable of forming an airflow to spray the gases inside the cavity R downward, i.e. to spray the gases inside the cavity R towards the press bed assembly 500.

The heat exchanger 30 has a heat exchange function and is disposed at a position where the airflow passage port C is located. A part of the heat exchanger 30 is exposed by the airflow passage port C, so that during a process of entering the cavity R through the airflow passage port C, the gases must pass through the heat exchanger 30 for heat exchange. It should be noted that heat exchange functional components in the heat exchanger 30 are exposed by the airflow passage port C, i.e., the gases entering the cavity R need to pass through the heat exchange functional components in the heat exchanger 30. The heat exchanger 30 herein is mainly for cooling purposes.

It should be understood that since the gases inside the cavity R are led out by the fan module 20, the negative pressure can be formed inside the cavity R. The negative pressure herein refers to an air pressure inside the cavity R being lower than an air pressure outside the box body 10, i.e., the air pressure inside the cavity R is lower than an air pressure inside the cabinet 400. It can be understood that the gases on a high pressure side will flow to a low pressure side, i.e., the gases inside the cabinet 400 enter the cavity R after passing through the airflow passage port C and the heat exchanger 30. As such, the gases inside the cavity R is cold air. Certainly, the cold air herein refers to gas that is cooler compared to the gases outside the box body 10, i.e., a temperature of the gases inside the cavity R is lower than a temperature of the gases outside the box body 10.

The fan module 20 sprays the cold air inside the cavity R downward toward the press bed assembly 500, so as to cool down the press bed assembly 500, thereby reducing the risk of excessive temperature of the press bed assembly 500 during operation processes of the press bed assembly 500.

In order to facilitate a better understanding of the solution, the solution is described in combination with FIG. 1. After the cold air sprayed downward from the heat exchanger integrated air duct assembly 100 exchanges heat with the press bed assembly 500, the temperature of the gases rises and flows around, i.e., hot air is mainly around the press bed assembly 500.

Meanwhile, the hot air around will flow upward. Since the negative pressure is formed inside the cavity R, the hot air passes through the airflow passage port C on either of the two sides of the box body 10 in the Y direction and enters the cavity R after being cooled down by the corresponding heat exchanger 30. Then the hot air is sprayed towards the press bed assembly 500 through the fan module 20.

It can be seen that the heat exchanger integrated air duct assembly 100 provided by the present disclosure is disposed above the press bed assembly 500, so that a heat exchange circulating airflow (shown by an arrow in FIG. 1) for dissipating the heat from the press bed assembly 500 can be formed inside the cabinet 400. During a process of detecting batteries by the battery detection device 1000, most of the heat generated at the press bed assembly 500 is taken away outside the cabinet 400 by the heat exchanger 30, so as to ensure that the press bed assembly 500 is within a suitable operating temperature range as much as possible, thereby ensuring the stability of the battery detection device 1000.

Furthermore, since the heat exchanger integrated air duct assembly 100 is located inside the cabinet 400 and above the press bed assembly 500, a width of the battery detection device 1000 is reduced, which is more conducive for transportation and can reduce a floor space. Furthermore, a distance from the heat exchanger integrated air duct assembly 100 to the press bed assembly 500 is relatively shorter, which can further provide a better heat dissipation effect.

In addition, since the heat exchanger integrated air duct assembly 100 is a component module of the battery detection device 1000, i.e., the heat exchanger integrated air duct assembly 100 adopts a modular layout design, which has better versatility and reduces equipment development costs.

It should be noted that the battery detection device 1000 herein may refer to a capacity-grading integrated machine used for detecting the batteries in a battery tray 700. The press bed assembly 500 includes a power module for detecting the batteries. During the process of detecting the batteries in the battery tray 700 by the press bed assembly 500, a temperature of the power module in the press bed assembly 500 and a temperature of the batteries in the battery tray 700 are increased, and thus the heat dissipation herein is mainly aimed at the heat generated during the detection process.

In addition, in the embodiments shown in FIG. 2 and FIG. 3, there are two heat exchangers 30, and the two heat exchangers 30 are disposed corresponding to the position of the airflow passage port C on either of the two sides of the box body 10 in the Y direction. Certainly, a number of the heat exchangers 30 is not limited to the illustrated embodiments, and may be an even number, such as four, or six, i.e., the heat exchangers 30 adopt a symmetrical layout.

In addition, the box body 10 in the drawing is a rectangular box body, i.e., the box body 10 adopts a six-sided box-shaped structure. Certainly, a shape of the box body 10 is not limited to the illustrated embodiments, and other multi-sided box-shaped structures, cylindrical structures, etc., may be adopted. Furthermore, the airflow passage port C in the illustrated drawings is a rectangular port, which is not limited thereto, and it is feasible to ensure that the airflow passage port C sufficiently exposes the heat exchange functional components of the heat exchanger 30.

In some embodiments, the battery detection device 1000 further includes a pipeline 600. The pipeline 600 is disposed on a top wall of the cabinet 400 and located outside the cabinet 400. The pipeline 600 is communicated with the heat exchanger 30 on either of the two sides of the box body 10 in the Y direction.

In these embodiments, the pipeline 600 is used for the flow of a heat exchange medium. A temperature of the heat exchange medium is lower than the temperature of the gases inside the cabinet 400. The heat exchange medium flows in the heat exchanger 30, thereby absorbing the heat of the gases passing through the heat exchanger 30 and taking the heat away outside the cabinet 400.

The heat exchange medium herein may be a fluid medium such as water, oil, or refrigerant. In a specific application, the water is used as the heat exchange medium, i.e., the heat exchanger 30 is a water medium heat exchanger. The heat exchanger 30 may be a pipe heat exchanger, a plate heat exchanger, etc. The heat exchange functional components of the heat exchanger 30 above correspond to a heat exchange capillary pipe in the pipe heat exchanger or a metal stacked plate of the plate heat exchanger.

Referring to FIG. 2, in some embodiments, the bottom wall of the box body 10 is provided with a fan installation guide rail 11 extending along an X direction. The fan module 20 is disposed to be able to slide into the cavity R along the fan installation guide rail 11.

In these embodiments, the bottom wall of the box body 10 is installed with the fan installation guide rail 11. The fan installation guide rail 11 is used for guiding the fan module 20 to slide into the cavity R along the X direction.

In order to prevent the fan installation guide rail 11 from interfering with the assembly of the fan module 20, one side of the box body 10 in the X direction is provided with a fan installation port H1. The fan installation port H1 is located at a position where the fan installation guide rail 11 is located. The fan module 20 is capable of passing through the fan installation port H1 and sliding along the fan installation guide rail 11 into the cavity R.

The fan module 20 is disposed to be able to be pulled along the X direction, which is convenient for assembly and subsequent maintenance.

In the specific application, the fan module 20 further includes a fan installation bottom plate 24. The fan installation guide rail 11 is a guide vertical plate extending along the X direction and disposed on either of two sides of the fan installation port H1 in the Y direction. The guide vertical plate on the two sides is provided with a guide slot capable of matching the fan installation bottom plate 24, so as to guide the fan module 20 to be inserted into the cavity R along the X direction.

Furthermore, one side of the fan module 20 in the X direction is provided with an X-side sealing plate (not shown in the figures). Under a condition that the fan module 20 is inserted into the cavity R, the X-side sealing plate covers the fan installation port H1, and the X-side sealing plate can be fixed together with the box body 10 by a screw connector to lock the fan module 20.

Referring to FIG. 2 and FIG. 4, one end of the fan module 20 in the X direction is provided with a pull handle 22.

In these embodiments, one end of the fan module 20 in the X direction further includes the pull handle 22. When the fan module 20 is assembled inside the box body 10, the pull handle 22 is located outside the box body 10, so that operators can conveniently insert the fan module 20 into the box body 10 in the X direction or pull out the fan module 20 from the box body 10 by pulling out the pull handle 22.

In some embodiments, the fan module 20 includes a plurality of fans 21. The plurality of fans 21 are arranged at intervals along the X direction. There are a plurality of fan modules 20. The plurality of fan modules 20 are arranged at intervals along the Y direction.

In these embodiments, the plurality of fan modules 20 are arranged inside the box body 10 at intervals along the Y direction. Each of the fan modules 20 includes the plurality of fans 21 arranged at intervals along the X direction, so that the plurality of fans 21 are arranged in a rectangular array.

The plurality of fans 21 herein are provided to form sufficient cold airflow, so as to ensure that the heat dissipation efficiency of the press bed assembly 500 is sufficient, thereby ensuring that the press bed assembly 500 works in a suitable operating temperature range for a long time during the operation processes.

It can be understood that when there are a plurality of the fan modules 20, the number of the fan installation guide rails 11 and the number of the fan installation ports H1 are equal to the number of the fan modules 20. In the embodiments shown in FIG. 2, the number of the fan modules 20 is three. Certainly, the number of the fan modules 20 can be adjusted according to heat dissipation requirements.

It should be understood that the number of the fan modules 20 can be adjusted according to the required heat dissipation efficiency. The number of fan modules 20 can be reduced as much as possible on the premise of meeting the heat dissipation requirements, thereby reducing the cost.

In some embodiments, the fan module 20 further includes a plurality of adapter plates 23. Each of the adapter plates 23 is disposed on one side of a corresponding one of the fans 21 in the Y direction. Each of the adapter plates 23 is provided with an electrical socket for connecting the corresponding one of the fans 21.

In these embodiments, each of the fans 21 corresponds to one of the adapter plates 23. Each of the adapter plates 23 is located on one side of the corresponding one of the fans 21 in the Y direction. Each of the adapter plates 23 is provided with the electrical socket. The electrical socket is connected to the corresponding one of the fans 21 to transmit electric energy.

With this arrangement, an electrical plug of each of the fans 21 can be correspondingly plugged into the nearby electric socket, thereby reducing a wire length of the electric plug, lowering the risk of interference due to excessive wire length, simplifying the complexity of the internal wiring of the fan module 20, and facilitating the disassembly and assembly of the fans 21.

It should be noted that in the specific application, each of the fans 21 and each of the adapter plates 23 are both fixedly installed on the corresponding fan installation bottom plate 24.

In some embodiments, the heat exchanger 30 is disposed to be able to be pulled along the X direction relative to the box body 10.

In the embodiments, in order to ensure that the heat exchanger 30 can be pulled along the X direction, one side of the box body 10 in the X direction is provided with a heat exchanger installation port H2. The heat exchanger installation port H2 allows the heat exchanger 30 to pass through and can be inserted into the box body 10 along the X direction.

By disposing that the heat exchanger 30 is able to be pulled along the X direction, it is more convenient to assemble the heat exchanger 30, and it is further convenient to subsequently inspect and maintain the heat exchanger 30.

In the specific application, the heat exchanger installation port H2 and the fan installation port H1 are located on the same side. One end of the heat exchanger 30 in the X direction is provided with a heat exchanger sealing plate (not shown in the figures). When the heat exchanger 30 is inserted into the cavity R, the heat exchanger sealing plate abuts against a sidewall of the box body 10 in the X direction and covers the heat exchanger installation port H2. The heat exchanger sealing plate can further be matched with a screw connector to realize the fixation of the heat exchanger 30 to the box body 10.

In some embodiments, the heat exchanger 30 includes a pipeline joint 31. The pipeline joint 31 protrudes outside the box body 10 in a state where the heat exchanger 30 is installed inside the box body 10.

In these embodiments, the heat exchanger 30 further includes the pipeline joint 31, and the pipeline joint 31 can cooperate with the pipeline 600 to lead the heat exchange medium which flows through the pipeline into the heat exchanger 30.

In the illustrated embodiments, each heat exchanger 30 corresponds to two pipe joints 31. One of the two pipe joints 31 serves as an inlet and the other one of the two pipe joints 31 serves as an outlet. Correspondingly, there are two pipelines 600. One of the two pipelines 600 serves as a liquid inlet pipe and the other one of the two pipelines 600 serves as a liquid outlet pipe, so that a circulating heat exchange medium circuit can be formed in conjunction with the heat exchanger 30.

In some embodiments, the box body 10 includes a plurality of lifting handles 12. The lifting handles 12 are disposed on the top wall of the box body 10.

In these embodiments, the top wall of the box body 10 is further fixedly equipped with a plurality of lifting handles 12, which is convenient for operators to carry and assemble. In these illustrated embodiments, the number of the lifting handles 12 is four. The lifting handles 12 is arranged close to corresponding four corners of the box body 10, respectively. Certainly, the number of the lifting handles 12 can be appropriately adjusted according to actual situations.

In summary, the heat exchanger integrated air duct assembly and the battery detection device provided by the present disclosure have at least beneficial effects as follows.

The heat exchange integrated air duct assembly provided by the present disclosure is disposed inside the cabinet of the battery detection device and located above the press bed assembly inside the cabinet of the battery detection device. The fan module disposed on the bottom wall of the cabinet in the heat exchange integrated air duct assembly can lead out the airflow inside the cavity, thereby forming the airflow sprayed towards the press bed assembly. As such, the negative pressure is formed inside the cavity, so as to allow the hot air outside the cavity to pass through the airflow passage port and be cooled down by the heat exchanger. That is, the gases in the cavity are cold air, and the gases sprayed towards the press bed assembly are cold air, thereby achieving the purpose of cooling.

The heat exchanger integrated air duct assembly provided by the present disclosure is disposed above the press bed assembly, so that the heat exchange circulating airflow for dissipating the heat from the press bed assembly can be formed inside the cabinet. During the process of detecting the batteries by the battery detection device, most of the heat generated at the press bed assembly is taken away outside the cabinet by the heat exchanger, so as to ensure that the press bed assembly is within a suitable operating temperature range as much as possible, thereby ensuring the stability of the battery detection device.

Furthermore, since the heat exchanger integrated air duct assembly is located inside the cabinet and above the press bed assembly, the width of the battery detection device is reduced, which is more conducive for transportation and can reduce the floor space. Furthermore, the distance from the heat exchanger integrated air duct assembly 100 to the press bed assembly 500 is relatively shorter, which can further provide the better heat dissipation effect.

In addition, since the heat exchanger integrated air duct assembly is a component module of the battery detection device, the heat exchanger integrated air duct assembly adopts the modular layout design, which has better versatility and reduces equipment development costs.

Although the embodiments of the present disclosure have been shown and described above, it can be understood that the above embodiments are exemplary and should not be construed as limitations of the present disclosure. Those skilled in the art can make changes, modifications, substitutions, and variations to the above embodiments within the scope of the present disclosure.

What is claimed is:

1. A heat exchanger integrated air duct assembly, comprising:
a box body, wherein a cavity is defined inside the box body, and an airflow passage port communicated with the cavity is defined on either of two sides of the box body in a Y direction;
at least one fan module disposed on a bottom wall of the box body, wherein the fan module is configured to spray gases inside the cavity downward to form a negative pressure inside the cavity; and
a heat exchanger, wherein at least a part of the heat exchanger is disposed inside the cavity and located on the two sides of the box body in the Y direction;
wherein a projection of the heat exchanger in the Y direction at least partially overlaps with the corresponding airflow passage port to cool down the gases entering into the cavity through the airflow passage port.

2. The heat exchanger integrated air duct assembly according to claim 1, wherein the bottom wall of the box body is provided with a fan installation guide rail extending along an X direction, and the fan module is configured to slide into the cavity along the fan installation guide rail.

3. The heat exchanger integrated air duct assembly according to claim 1, wherein the fan module comprises a plurality of fans, and the plurality of fans are arranged at intervals along the X direction; and
wherein the heat exchanger integrated air duct assembly comprises a plurality of the fan modules, and the plurality of the fan modules are arranged at intervals along the Y direction.

4. The heat exchanger integrated air duct assembly according to claim 3, wherein the fan module further comprises a plurality of adapter plates, and each of the plurality of adapter plates is located on one side of a corresponding one of the plurality of fans in the Y direction and provided with an electrical socket for connecting the corresponding one of the plurality of fans.

5. The heat exchanger integrated air duct assembly according to claim 1, wherein one end of the fan module in an X direction is provided with a pull handle.

6. The heat exchanger integrated air duct assembly according to claim 1, wherein the heat exchanger is configured to be pulled along the X direction relative to the box body.

7. The heat exchanger integrated air duct assembly according to claim 1, wherein the heat exchanger comprises a pipeline joint; and
wherein in a state where the heat exchanger is installed inside the box body, the pipeline joint protrudes outside the box body.

8. The heat exchanger integrated air duct assembly according to claim 1, wherein the box body comprises a plurality of lifting handles, and the plurality of lifting handles are disposed on a top wall of the box body.

9. A battery detection device, comprising a cabinet, a press bed assembly, and a heat exchanger integrated air duct assembly;
wherein the heat exchanger integrated air duct assembly and the press bed assembly are arranged inside the cabinet, and the heat exchanger integrated air duct assembly is located above the press bed assembly in a Z direction;
wherein the heat exchanger integrated air duct assembly is capable of spraying an airflow toward the press bed assembly to dissipate heat from the press bed assembly;
wherein the heat exchanger integrated air duct assembly comprises:
a box body, wherein a cavity is defined inside the box body, and an airflow passage port communicated with the cavity is defined on either of two sides of the box body in a Y direction;
at least one fan module disposed on a bottom wall of the box body, wherein the fan module is configured to spray gases inside the cavity downward to form a negative pressure inside the cavity; and
a heat exchanger, wherein at least a part of the heat exchanger is disposed inside the cavity and located on the two sides of the box body in the Y direction; and
wherein a projection of the heat exchanger in the Y direction at least partially overlaps with the corresponding airflow passage port to cool down the gases entering into the cavity through the airflow passage port.

10. The battery detection device according to claim 9, wherein the battery detection device further comprises a pipeline; and
wherein the pipeline is disposed on a top wall of the cabinet and is located outside the cabinet, and the pipeline is communicated with the heat exchanger on the two sides of the box body in the Y direction.

11. The battery detection device according to claim 9, wherein the bottom wall of the box body is provided with a fan installation guide rail extending along an X direction, and the fan module is configured to slide into the cavity along the fan installation guide rail.

12. The battery detection device according to claim 11, wherein one side of the box body in the X direction is provided with a fan installation port, the fan installation port is located at a position where the fan installation guide rail is located, and the fan module is capable of passing through the fan installation port and sliding along the fan installation guide rail into the cavity.

13. The battery detection device according to claim 9, wherein the fan module comprises a plurality of fans, and the plurality of fans are arranged at intervals along the X direction; and
wherein the heat exchanger integrated air duct assembly comprises a plurality of the fan modules, and the plurality of the fan modules are arranged at intervals along the Y direction.

14. The battery detection device according to claim 13, wherein the fan module further comprises a plurality of adapter plates, and each of the plurality of adapter plates is located on one side of a corresponding one of the plurality of fans in the Y direction and provided with an electrical socket for connecting the corresponding one of the plurality of fans.

15. The battery detection device according to claim 14, wherein the fan module further comprises a fan installation bottom plate, and each of the plurality of fans and each of the plurality of adapter plates are fixedly installed on the corresponding fan installation bottom plate.

16. The battery detection device according to claim 9, wherein one end of the fan module in an X direction is provided with a pull handle.

17. The battery detection device according to claim 9, wherein the heat exchanger is configured to be pulled along the X direction relative to the box body.

18. The battery detection device according to claim 17, wherein one side of the box body in the X direction is provided with a heat exchanger installation port, and the heat exchanger installation port allows the heat exchanger to pass through and is inserted into the box body along the X direction.

19. The battery detection device according to claim 9, wherein the heat exchanger comprises a pipeline joint; and
wherein in a state where the heat exchanger is installed inside the box body, the pipeline joint protrudes outside the box body.

20. The battery detection device according to claim 9, wherein the box body comprises a plurality of lifting handles, and the plurality of lifting handles are disposed on a top wall of the box body.
